(19) United States
(12) Patent Application Publication
(10) Pub. No.: US 2006/0236145 A1
(43) Pub. Date: Oct. 19, 2006

(54) Contents reproduction device

(76) Inventors: Takafumi Yuasa, Yokohama (JP); Yukio Fujii, Yokohama (JP); Kazuhiko Tanaka, Fujisawa (JP); Koji Hosogi, Hiratsuka (JP); Hiroaki Nakata, Yokohama (JP); Masakazu Ehama, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/214,868

(22) Filed: Aug. 31, 2005

(30) Foreign Application Priority Data
Apr. 14, 2005 (JP) 2005-116397

(51) Int. Cl. G06F 1/32

(52) U.S. Cl. 713/324

(57) ABSTRACT

A contents reproduction device realizes reduction of power consumption by controlling power supply control according to the input contents. More specifically, in the contents reproduction device, the PSI analysis unit analyzes additional information in the inputted contents so as to check whether video contents are contained or the signal detection unit checks whether the inputted contents contain a video signal. According to the check result, the video information detection unit detects whether the inputted contents contain video information and outputs the detection result to the power control unit. When the inputted contents contain video information, the power control unit supplies power to the display. When no video information is contained, the power control unit stops power supply to the display and turns off power supply to the display.

### INCORPORATION BY REFERENCE

The present application claims priority from Japanese application JP2005-116397 filed on Apr. 14, 2005, the content of which is hereby incorporated by reference into this application.

### BACKGROUND OF THE INVENTION

The present invention relates to a contents reproduction device and in particular, to a contents reproduction device capable of controlling power according to the type of reproduction contents and a power control method.

Recently, various electronic devices have a function for realizing power saving. In the case of a television receiver, a power control mechanism is provided for automatically turning of the power source of the receiver, thereby realizing the power saving. The power control mechanism has means for detecting a state that a user does not watch the television even when the power supply is ON. When such a state is detected, the power supply to the television receiver is automatically controlled to turn off to realize power saving. Concerning this point, for example, JP-A-6-78246 discloses such a method that a sensor provided in the television receiver is used to check whether a viewer is present, the check result is reported to the power control unit, and if the viewer leaves the television viewing seat while the power supply to the television receiver is ON and the viewer's absence has lasted for a predetermined time, the power supply to the television receiver is automatically turned off.

### SUMMARY OF THE INVENTION

However, in the aforementioned television receiver, it is impossible to turn on or off the power supply to the display unit and the loudspeaker unit independently of the tuner unit, for example. That is, what can be done is only to control the power supply to the entire television receiver.

Furthermore, there has been a problem that power supply control cannot be performed according to the type of contents of the channel being reproduced.

It is therefore an object of the present invention to provides a contents reproduction device and a judgment method for judging the contents being reproduced and controlling a plurality of power supplies independently from one another according to the judgment result.

In order to achieve the aforementioned object, the contents reproduction device judges the contents being reproduced by the contents judgment means. That is, it is judged at least whether the contents include video or do not include audio and video such as data. When the inputted contents do not contain video and the power supply to the video processing means is on, the power supply is turned off. When the contents include video and the power supply to the video processing means is off, the power supply is turned on.

According to the present invention, power supply control is performed according to the contents being reproduced and it is possible to suppress unnecessary power consumption.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a contents reproduction device and external devices connected to it.

FIG. 2 shows an example of a remote controller used by a viewer to operate the contents reproduction device shown in FIG. 1.

FIG. 3 shows an example of a table held by the storage device of the contents reproduction device shown in FIG. 1.

FIG. 4 is a flowchart showing an example of a reproduction contents judgment procedure in the contents judgment unit.

FIG. 5 is a flowchart showing an example of a display power supply automatic control processing in the power supply control unit.

FIG. 6 is a flowchart showing an example of the power supply control processing when the display power supply is manually operated by the viewer.

FIG. 7 is a flowchart showing an example of a power supply control processing when the power supply to the contents reproduction device is operated via the power supply control unit.

FIG. 8 is a flowchart showing an example of related data broadcast display processing when data broadcast related to the contents are present.

FIG. 9 is a diagram showing allocation of stream_type.

### DETAILED DESCRIPTION OF THE EMBODIMENTS

Description will now be directed to an embodiment of the present invention with reference to the attached drawings.

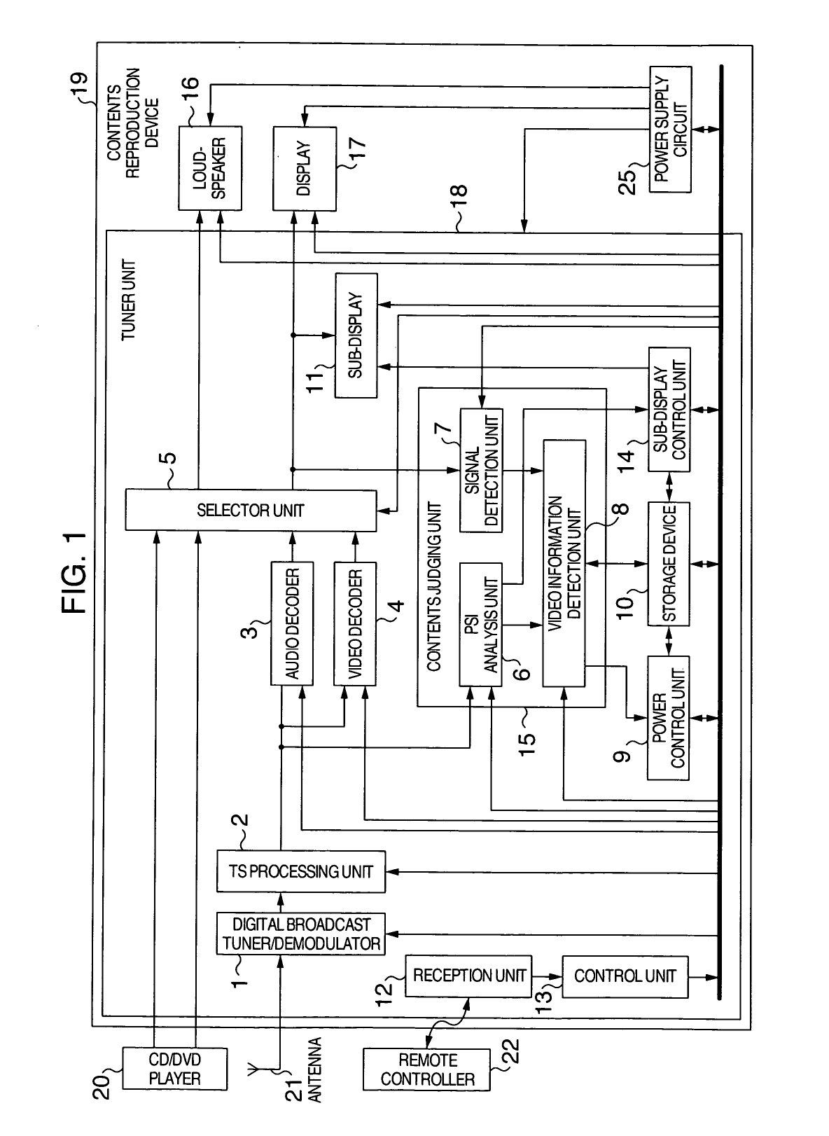

FIG. 1 is a block diagram showing an entire configuration of the contents reproduction device according to the present embodiment and external devices connected to it.

In FIG. 1, the contents reproduction device 19 includes a loudspeaker 16, a display 17, a tuner unit 18, and a power supply circuit 25.

The power supply circuit 25 supplies power to the loudspeaker 16, the display 17, and the tuner unit 18 and can control power supply amount independently for each of them according to an inputted control signal.

An antenna 21 receives a broadcast wave transmitted from a television broadcast station and supplies it to the tuner unit 18 of the contents reproduction device 19.

A digital broadcast tuner/demodulator 1 demodulates the received broadcast wave and outputs MPEG-2 TS (transport stream) as the demodulation result to a TS processing unit 2. The TS processing unit 2 isolates each data from the TS and outputs them to the latter stage.

An audio decoder 3 decodes the audio data inputted from the TS processing unit 2 and outputs it. A video decoder 4 decodes video data inputted from the TS processing unit 2 and outputs it.

A selector unit 5 is supplied with the output of the audio decoder 3, the output of the video decoder 4, video and audio signals from a CD/DVD player 20 as an external device connected to the external input terminal of the contents reproduction device. The selector unit 5 selects the video decode result and the audio decode result of the broadcast wave or a signal output from one of the devices connected to the external input terminal, outputs the audio data inputted from the selected system to the loudspeaker 16, outputs video data to the display 17, and outputs the related data contents to a sub-display 11.

The sub-display built in the tuner unit 18 is, for example, a small-size liquid crystal display device for displaying the data broadcast partially or entirely. It should be noted that the sub-display may be configured so that it is displayed on a part or whole of the display 17 for the video display.

A PSI analysis unit 6 analyzes the PSI (program specification information) isolated from the TS in the TS processing unit 2 and judges whether the program includes video contents. The analysis method will be detailed later.

A signal detection unit 7 is connected to a video signal output line of the selector unit 5 and detects whether a video signal is present.

A video information detection unit 8 judges whether the reproduction contents include video information according to the output result of the PSI analysis unit 6 and the output result of the signal detection unit 7 and generates a judgment signal indicating the judgment result. The PSI analysis unit 6, the signal detection unit 7, and the video information detection unit 8 constitute a contents judgment unit 15.

A power control unit 9 outputs to the power supply circuit 25 a display power supply control signal for controlling the power amount supplied to the display 17 according to the judgment signal generated by the contents judgment unit 15 and the table value held in the storage device 10.

A sub-display control unit 14 issues a control instruction indicating whether to perform display processing for the sub-display 11 according to the output result of the PSI analysis unit 6 and the table value held in the storage device 10.

A viewer presses a button provided on the remote controller 22 to operate the contents reproduction device 19. The signal sent from the remote controller 22 is received by the reception unit 12 of the tuner unit 18 and the reception result is outputted to the control unit 13. The control unit 13 transmits a control instruction corresponding to the operation to a predetermined function block in the contents reproduction device 19. The control instruction, for example, is a power supply operation of the contents reproduction device 19.

Here, several ways of power supply operation of the contents reproduction device 19 can be considered depending on whether the contents reproduction device 19 is in power on state or power off state. The power on state or power off state of the contents reproduction device 19 means that the loudspeaker 16, the display 17, and the tuner unit 18 are all in the power on state or power off state. Moreover, in this embodiment, the power off state represents the so-called stand-by state. For example, when the tuner unit 18 is in the stand-by state, power is supplied to the reception unit 12 and the control unit 13 by the power supply circuit 25. Here, the stand-by state means that the control unit 9, the power supply circuit 25, the sub-display control unit 14, and the reception unit 12 are electrically connected and can receive the operation of the remote controller such as power on operation.

It should be noted that each of the function blocks shown in FIG. 1 may be realized by hardware such as an arbitrary CPU (not depicted), a memory, or other LSI. As for software, the function blocks are realized by the CPU which interprets and executes a program realizing the function blocks loaded in the memory. Moreover, as is known by those skilled in the art, these function blocks can be realized in various formats by hardware alone, or software alone, or their combinations. It should be noted that each program or data is stored in a storage device such as a memory or hard disc device (not depicted).

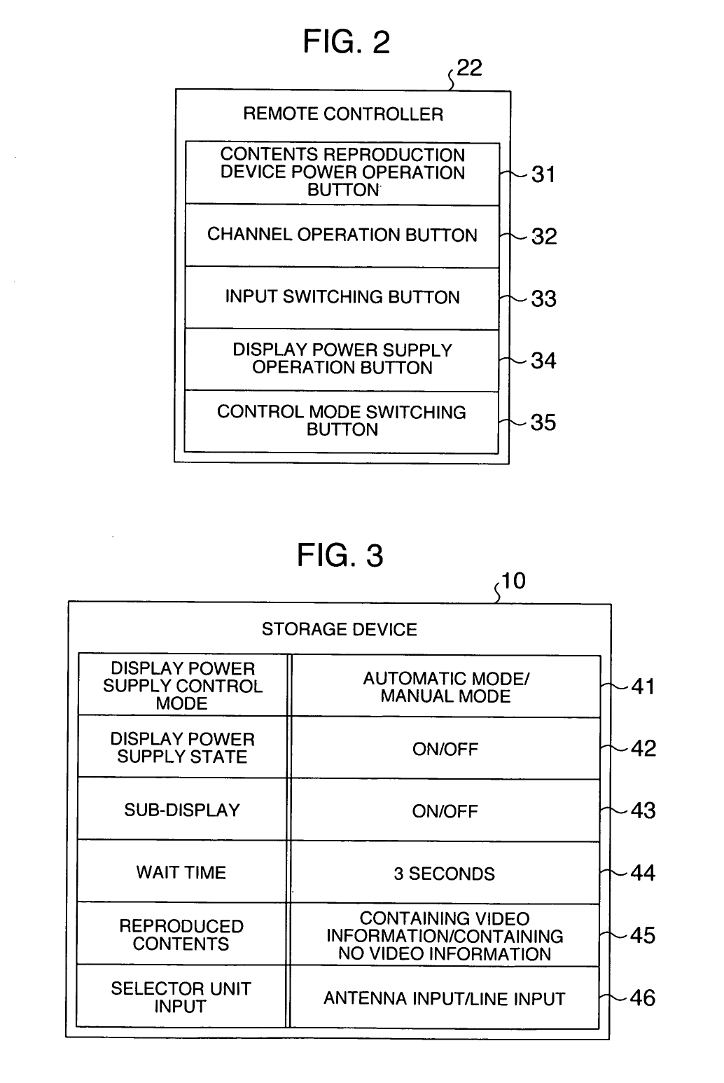

FIG. 2 shows an example of a remote controller used by a viewer to operate the contents reproduction device 19 in the present embodiment. The remote controller 22 has various buttons such as a contents reproduction device power operation button 31 for turning on or off the power supply to the contents reproduction device 19, a channel operation button 32 for switching the television broadcast reception channels, an input switching button 33 for selecting a contents input system in the selector unit 5, a display power supply operation button 34 for turning on or off the power supply to the display 17, and a control mode switching button 35 for switching whether to perform automatic control of the display power.

FIG. 3 shows items of the table held by the storage device 10 of the contents reproduction device 19.

A display power control mode 41 defines whether the contents reproduction device 19 is set to automatic mode for automatically controlling the display power supply or manual mode in which only the viewer's operation controls the display power supply.

The display power supply state 42 defines whether power supply to the display 17 is in the on state or in the off state.

The sub-display 43 defines whether related data broadcast is to be displayed on the sub-display 11.

The wait time 44 defines the wait time when the wait processing of a predetermined time is performed by the power control unit 9. Here, for example, when the viewer is switching channels, a channel not broadcasting any program is temporarily displayed on the receiver. In this case, the viewer is expected to promptly switch to a different channel. In such a condition, if the display power is promptly turned off, this deteriorates the user-friendliness and a wait processing of a predetermined time is provided.

The reproduced contents 45 define whether the contents being reproduced contain video information.

The selector unit input 46 defines whether the selector unit 5 has selected the antenna input or external input as the contents input system.

In a digital broadcast, the MPEG-2 TS is employed as the transmission method. In the TS, in addition to the contents such as video data, audio data, data broadcast, and EPG (electronic program table), time information used for display control, control information such as synchronization information between transmission and reception and various service information, and additional information are transmitted. By the PSI which is one of the information contained in the TS, the PID (packet identifier) containing a component such as video and audio in each program is transmitted. Accordingly, by analyzing the PSI, it is possible to check whether the program includes video contents.

Here, explanation will be given on the judgment method how to decide presence/absence of the component such as video or audio.

Each of the packets in TS, contains information called PID (packet identifier) indicating the information transmitted by the packet. The same contents containing the same image and audio have the same PID. The PSI (program specification information) contained in the TS is 13-bit information for identifying the information stored in the packet having a particular PID. PID=0×0000 is PAT (Program Association Table), PID=0×0001 is CAT (Conditional Access Table), and PID=0×0010 to 0×1FFF are PMT (Program Map Table).

The PMT contains PID such as video, audio, additional information contained in a program. The PAT contains a program transmitted by a TS and a list of PID of PMT corresponding to the program. By the PAT and PMT in the PSI, the PID of the video and audio are acquired and by acquiring the packet added by their PID, it is possible to reproduce contents such as a moving picture.

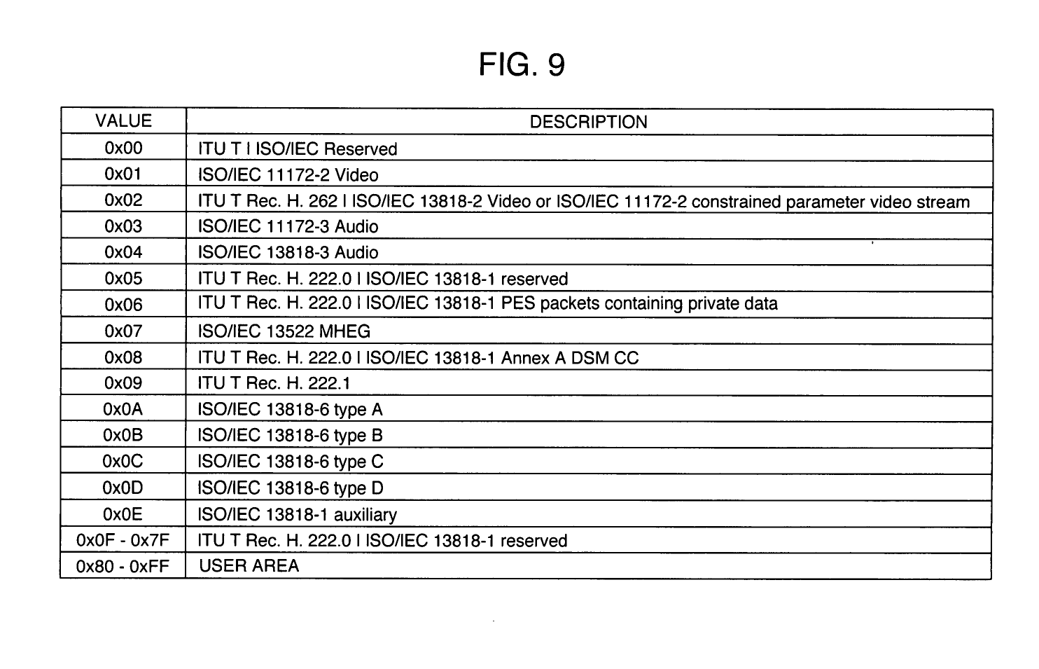

The PMT section contains 8-bit information which is called stream_type for identifying the type of the information contained in the packet having the corresponding PID (see FIG. 9). Thus, it is possible to judge whether video contents are included according to the value of the stream_type.

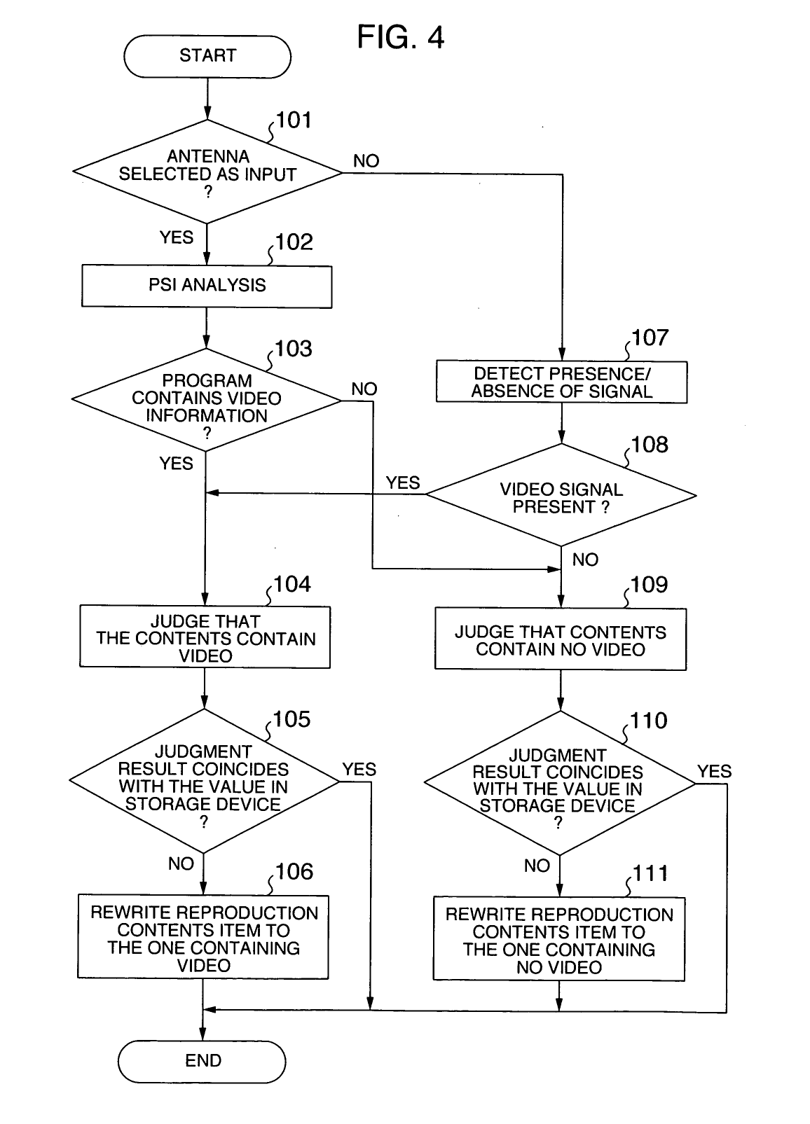

Next, by referring to the flowchart of FIG. 4, explanation will be given on the processing procedure when the contents judging unit 15 in the contents reproduction device judges the input contents.

Firstly, the video information detection unit 8 reads out the value of the selector unit input 46 and detects whether the antenna input is selected or the external input is selected as an input system by the selector unit 5 (step 101).

If the antenna input is selected, the PSI analysis unit 6 analyzes the PSI contained in the TS to check the video information in the program being broadcast by the channel selected by the viewer (step 102), detects whether video information is present (step 103), and outputs the detection result to the video information detection unit 8.

Here, in the packet contained in the contents being reproduced, when the stream_type indicates a specification such as encoding for the video, for example, ISO/IEC 11172-2 Video (MPEG-1 Video), it is judged that video information is present.

When the video information is present, it is judged that the contents being reproduced are contents containing video (step 104) and a value of the reproduction contents 45 held by the storage device 10 is read out. If the value indicates that no video is contained, the value of the reproduction contents 45 is rewritten to the one containing video.

Moreover, when no video information is contained, the contents being reproduced are judged to be contents having no video (step 109), the value of the reproduction contents 45 held by the storage device 10 is read out. If the value indicates that video is contained, the value of the reproduction contents 45 are rewritten to the one having no video.

Moreover, if step 101 indicates that an external input is selected, the signal detection unit 7 checks the signal outputted from the selector unit 5 (step 107) and detects whether a video signal is present (step 108). As a detection method, for example, it is possible to detect presence/absence of a synchronization signal in the input signal so as to detect whether a video signal is present.

The detection result is outputted to the video information detection unit 8. When a video signal is detected, the video information detection unit 8 judges that the contents being reproduced are contents containing video (step 104) and compares the judgment result to the value of the reproduction contents 45 held by the storage device 10 (step 105). If the comparison result indicates that the values are different, the value of the reproduction contents 45 are rewritten to the one containing video (step 106). If no video signal is detected, the video information detection unit 8 judges that the contents being reproduced are contents having no video (step 109) and compares the judgment result to the value of the reproduction contents 45 held by the storage device 10 (step 110). If the values are different, the value of the reproduction contents 45 is rewritten to the one having no video (step 111).

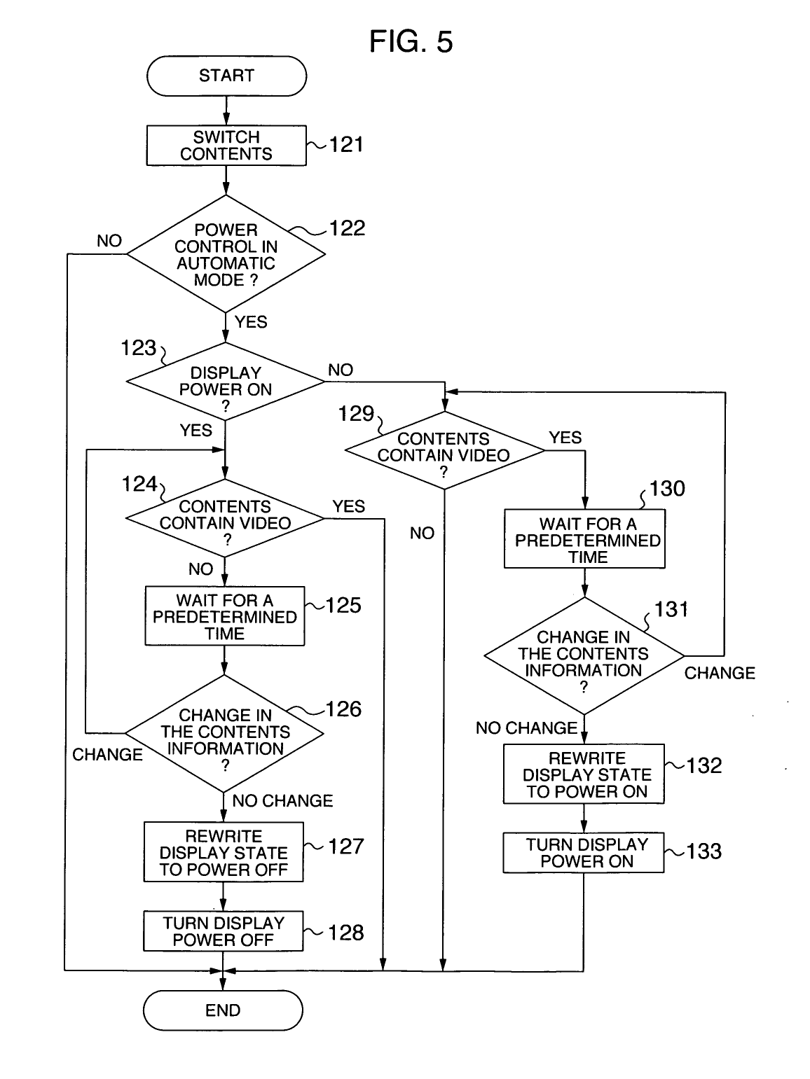

Next, referring to the flowchart of FIG. 5, explanation will be given on the processing procedure for controlling the display power supply in the contents reproduction device.

The reproduction contents in the contents reproduction device are switched when a viewer presses the channel operation button 32 of the remote controller 22 or the viewer presses the input switching button 33 to switch the contents input system of the selector unit 5 (step 121).

When the reception channel is switched by the viewer, the control unit 13 transmits a control signal to the digital broadcast tuner/demodulator 1, the TS processing unit 2, the audio decode, the video decoder 4, and the like, thereby switching the channel.

When the input system is switched/operated by the viewer, the control unit 13 transmits a control signal to the select unit 5 to switch the input system from the antenna input to the external input of from the external input to the antenna input, or from the external input to the different external input, and transmits a control signal to the storage device (10) and rewrites the value held by the select unit input 46 to the input system after the switching.

The control unit 13 reports to the power control unit 9 that the reproduction contents have been switched. Upon reception of this report, the power control unit 9 reads out the display power control mode 41 to check whether the mode is automatic mode (step 122). If the display power control mode is not automatic mode, i.e., manual mode, the power supply state of the display 17 before the contents switching is maintained.

When the display power control mode is automatic mode, the power control unit 9 reads out the value of the display power supply state 42 to check whether the power supply state of the display 17 is on or off (step 123).

When the display 17 is in the power on state, the power control unit 9 checks whether the contents being reproduced contain video information according to the judgment signal as the output result of the contents judging unit 15 (step 124).

When video information is contained, the display 17 is in the power on state and the video contents are reproduced. Accordingly, the power control unit 9 maintains the power supply state of the display 17 before the contents switching.

When the contents being reproduced do not contain video contents, the power control unit 9 reads out the value of the wait time 44 and waits for the time specified by this (step 125) and checks whether a contents switching operation has been caused again during the wait time and checks whether a change has been caused in the judgment result inputted from the contents judging unit 15 during the wait time (step 126).

When a contents switching operation is caused of a change has been caused in the judgment result, control is returned again to step 124 after the wait time and the power control unit checks whether the contents being produced contain a video.

When no change has occurred in the judgment result or no contents switching operation has occurred during the wait time, the power control unit 9 rewrites the display power supply state 42 to off (step 127), outputs a control signal to turn off the power supply to the display 17, and turns off the power supply to the display 17 (step 128).

When the display 17 is in the power off state in step 123, the power control unit 9 uses the judgment signal as the output result of the contents judging unit 15 to check whether the contents being reproduced contain video information (step 129).

When no video information is contained, the power control unit 9 maintains the power supply state of the display 17 before the contents switching. As the case that no video contents are contained, there is a case that contents not containing video such as radio broadcast are reproduced or a case that an external input is selected as the input system in the selector unit 5 but no contents are reproduced or music CD is reproduced in the CD/DVD player 20 connected as the external device.

When video information is contained, like steps 125 and step 126, the power control unit 9 reads out the value of the wait time 44 and waits for the time specified by this (step 130) and checks whether a contents switching operation has occurred during the wait time or whether a change has occurred in the judgment result inputted from the contents judging unit 15 during the wait time (step 131).

When a contents switching operation has occurred or a change has occurred in the judgment result during the wait time, control is returned again to step 129 after the wait time and the power control unit 9 checks whether the contents being reproduced contain video information.

When no contents switching operation has occurred or no change has occurred in the judgment result during the wait time, the power control unit 9 rewrites the display power supply state 42 to on (step 132), outputs a control signal to turn on the power supply to the display 17, and turns on the power supply to the display 17 (step 133).

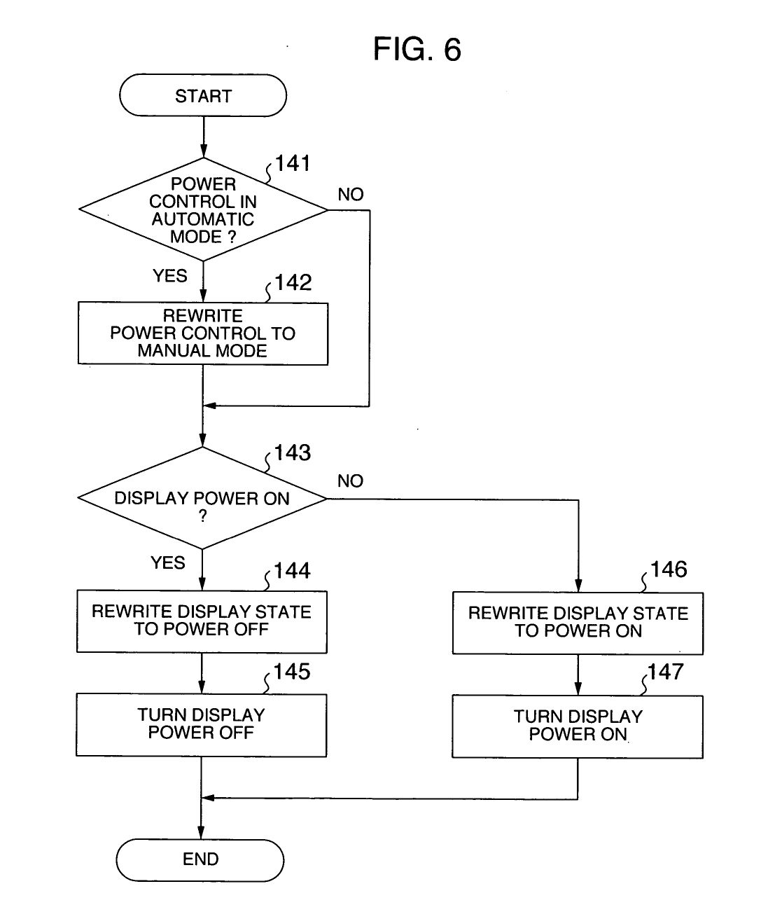

Next, by referring to the flowchart of FIG. 6, explanation will be given on the processing procedure when the viewer turns on or off the power supply to the display 17.

When the viewer presses the display power operation button 34 of the remote controller 22, the operation is transmitted via the reception unit 12 to the control unit 13. The control unit 13 receives the operation and issues a control instruction, which is inputted to the power control unit 9. The power control unit 9 reads out the value of the display power supply control mode 41 to check whether the automatic mode or the manual mode is set (step 141). When the automatic mode is set, the display power supply control mode 41 is rewritten to the manual mode (step 142). When the manual mode is set, the value is maintained. Subsequently, the power control unit 9 reads out the value of the display power supply state 42 to check whether the display 17 is in the power on state or power off state (step 143).

When the display 17 is in the power on state, the power control unit 9 rewrites the display power supply state 42 to the power off state (step 144), outputs a control signal to turn off the power supply to the display 17, and turns off the power supply to the display 17 (step 145).

When the display 17 is in the power off state in step 143, the power control unit 9 rewrites the display power supply state 42 to the power on state (step 146), outputs a control signal to turn on power of the display 17, and turns on the display power supply (step 147).

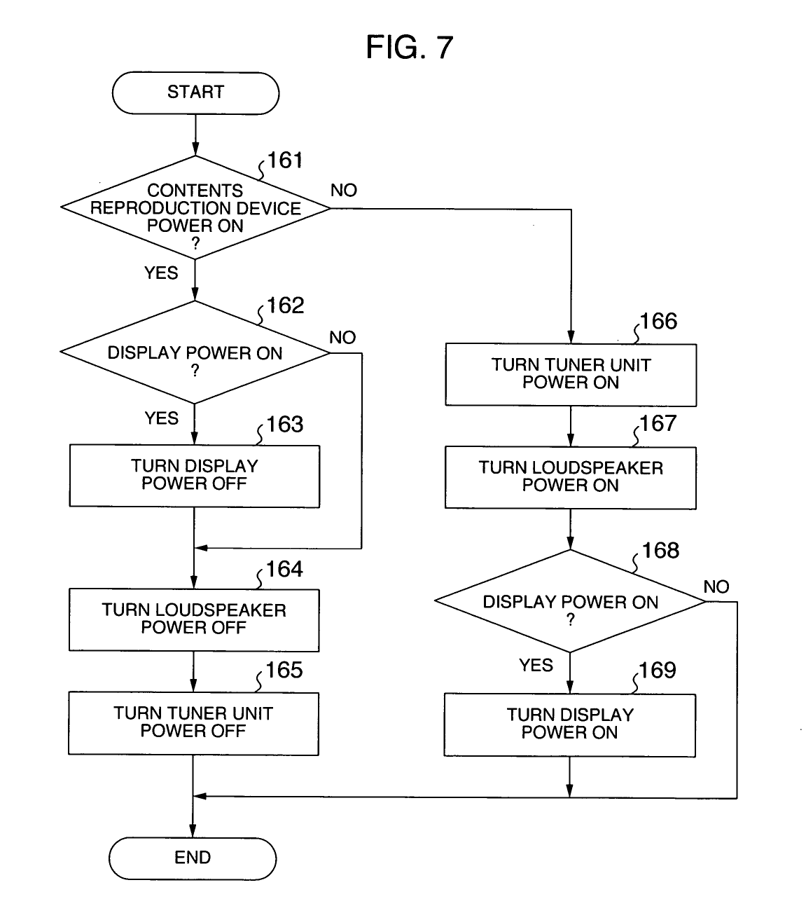

Next, by referring to the flowchart of FIG. 7, explanation will be given on the processing procedure when the viewer operates to turn on or turn off the power supply to the contents reproduction device.

When the viewer presses the contents reproduction device power operation button 31 of the remote controller 22, the operation is transmitted via the reception unit 12 to the control unit 13. Upon reception of the operation, the control unit 13 checks whether power supply to the contents reproduction device 19 is in the on state or off state (step 161) and transmits the check result to the power control unit 9.

When the power supply to the contents reproduction device is in the on state, the power control unit 9 reads out the value of the display power supply state 42 to check whether the power supply to the display 17 is in the power on state or in the power off state (step 162).

When the display 17 is in the power on state, the power control circuit 9 outputs a control signal to turn off the power supply to the display 17, and turns off the display power supply (step 163).

When the display 17 is in the power on state, no power supply operation is performed for the display 17.

Subsequently, the power control circuit 9 outputs a control signal to turn off the power supply to the loudspeaker 16 and turns off the power supply to the loudspeaker 16 (step 164). The power control circuit 9 outputs a control signal to turn off power supply to the tuner unit 18 and turns off the power supply to the tuner unit 18 (step 165).

On the other hand, in step 161, when the power supply to the contents reproduction device 19 is in the off state, the power control unit 9 issues a control instruction to turn on the power supply to the tuner unit 18 (step 166) and turns on the power supply to the loudspeaker 16 (step 167).

Next, the power control unit 9 reads out the value of the display power supply state 42 and checks the display power supply state when the power supply to the contents reproduction device is turned off (step 168). If the display power supply state 42 is on, the power control unit 9 issues a control instruction and turns on the power supply to the display 17 (step 169) and if the display power supply state 42 is off, the power control unit 9 does not perform power supply operation for the display 17.

When the power off operation is performed for the display 17 in step 163, the value of the display power supply state 42 is not rewritten. Accordingly, the storage device 10 can store the power supply state of the display 17 immediately before the power supply to the contents reproduction device 19 is turned off. Thus, when the power supply to the contents reproduction device is turned on, the power control circuit 9 can reproduce the display power supply state at the power off state.

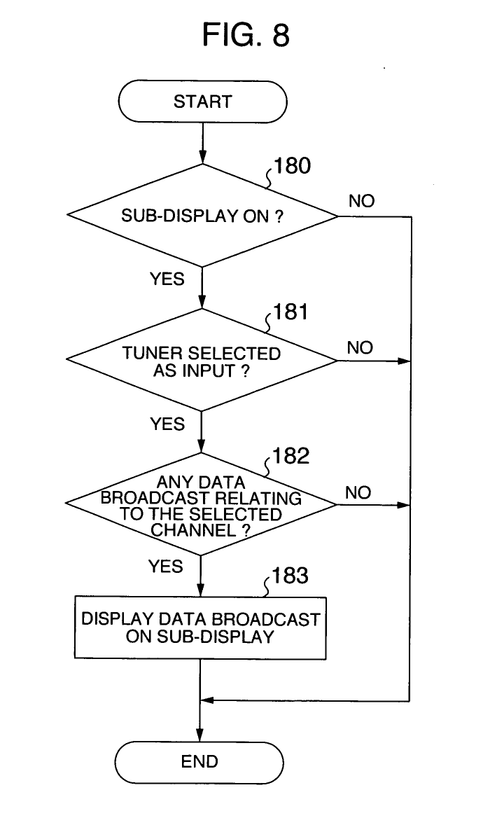

Referring to the flowchart of FIG. 8, explanation will be given on the reproduction display processing procedure of data broadcast related to the contents inputted to the contents reproduction device 19.

The sub-display control unit 14 reads out the value of the sub-display 43 and checks the display setting (step 180). When the sub-display is set to off, no display is performed on the sub-display 11. When the sub-display is set to on, the sub-display control unit 14 reads out the value of the selector unit input 46 and checks whether the antenna input or the external input is selected as the input system (step 181). When the external input is selected, the viewer is not viewing the television broadcast received by the antenna 21 and accordingly, no display processing is performed to the sub-display 11. When step 181 indicates that the antenna input is selected, the sub-display control unit 14 uses the analysis result of the PSI analysis unit 6 to check whether data broadcast related to the broadcast channel currently selected by the viewer is performed (step 182). When no related data broadcast is performed, no display is performed on the sub-display 11. When a related data broadcast is performed, the contents are displayed on the sub-display 11 (step 183).

In the aforementioned embodiment, explanation has been given on a digital television broadcast as an example of input contents using the PSI for video information detection. However, the present embodiment is not limited to the digital television broadcast but can be applied to a contents input using the TS such as digital audio broadcast.

Moreover, explanation has been given on a case that operation of the contents reproduction device is performed via the remote controller. However, the operation mechanism may be provided on the contents reproduction device.

Moreover, in this embodiment, explanation has been given on the contents reproduction device. However, the present invention can be applied to other device if it has a display unit, a loudspeaker unit, and a tuner unit. For example, when the present embodiment is applied to a television receiver-equipped mobile telephone, it is possible to suppress consumption of the battery. Moreover, when the present embodiment is applied to a liquid crystal television or a plasma television, it is possible to prolong the service life of the panel.

It should be further understood by those skilled in the art that although the foregoing description has been made on embodiments of the invention, the invention is not limited thereto and various changes and modifications may be made without departing from the spirit of the invention and the scope of the appended claims.

1. A contents reproduction device comprising a video display device and an audio output device, the contents reproduction device further comprising:
input unit which inputs information including contents;
contents judging unit which judges whether the contents contain video information; and
power supply unit capable of controlling power supplied to the display device and the audio output device;
wherein when the contents judging unit judges decides that the contents do not contain video information, the power supply unit supplies to the audio output device, and
when the contents judging unit judges that the contents contain video information, the power supply unit supplies power to the audio output device and to the video display device.

2. A contents reproduction device as claimed in claim 1, wherein the contents judging unit analyzes a packet identifier contained in the information and decides whether the contents contain video.

3. A contents reproduction device as claimed in claim 1, wherein
the input unit includes first contents input unit and second contents input unit,
the contents judging unit includes first contents judging unit which decides whether the contents inputted to the first contents input unit contain video information, and second contents judging unit which decides whether the contents inputted to the second contents judging unit contain video information,
the contents reproduction device further comprising contents selection unit which selects input from the first contents input unit or from the second contents input unit,
wherein when the contents selection unit has selected the first contents input unit, the power supply unit is controlled according to the judgment result of the first contents judging unit and when the contents selection unit has selected the second contents input unit, the power supply unit is controlled according to the judgment result of the second contents judging unit.

4. A contents reproduction device as claimed in claim 3, wherein the first contents input unit is antenna input unit and the second contents unit is external input means.

5. A contents reproduction device as claimed in claim 3, wherein
the first contents judging unit analyzes the packet identifier contained in the information and decides whether the contents contain video, and
the second contents judging unit detects whether a video signal exists in the signals outputted from the contents selection unit and decides whether the contents contain video.

6. A contents reproduction device as claimed in claim 1, wherein
the power supply unit includes storage unit containing a value indicating whether power is supplied to the video display device, and
the value stored in the storage unit is modified according to the output from the contents judging unit.
